(19) United States
(12) Patent Application Publication
(10) Pub. No.: US 2008/0170906 A1
(43) Pub. Date: Jul. 17, 2008

(54) Adapter For The Interconnection Of Components And A Component Manufactured Using Such An Adapter

(75) Inventor: Mario Schmidt, Moers (DE)

Correspondence Address: PROSKAUER ROSE LLP, ONE INTERNATIONAL PLACE, BOSTON, MA, 02110, US

(73) Assignee: THYSSENKRUPP STEEL AG, Duisburg (DE)

(21) Appl. No.: 11/572,248

(22) PCT Filed: Jul. 16, 2005
(86) PCT No.: PCT/EP05/07771

§ 371 Date: Nov. 8, 2007

(30) Foreign Application Priority Data
Jul. 19, 2004 (DE) 102004034817.0-12

(51) Int. Cl. F16B 1/00

(52) U.S. Cl. 403/179

(57) ABSTRACT

The invention relates to an adapter, which in a simple manner enables secure connection of two components (A1, A2, A3, A4, T1, T2, T3, T4) manufactured from different materials. This is achieved according to the invention in that the adapter has a basic element (5, 6, 7, 8) which is manufactured from a material which belongs to the group of materials to which the material of the first component (A1, A2, A3, A4) is allocated, and a connection element (10, 19, 24, 25, 28, 29) indissolubly connected by a joint operation positively and non-positively to the basic element (5, 6, 7, 8), said connection element being manufactured from a material which belongs to the group of materials to which the material of the second component (T1, T2, T3, T4) is allocated. In addition to this, the invention relates to a component produced using an adapter according to the invention.

The invention relates to an adapter for the connection of a component consisting of a first material to a component consisting of a second material. In addition, the invention relates to a component manufactured from a first component consisting of a first material and from a second component manufactured from a material belonging to a material group other than the material of the first component.

In the sector of motor vehicle bodywork construction in particular, as well as in other sectors of technology, in which components manufactured from different materials have to be joined to one another, the problem frequently arises that the materials concerned cannot be connected to one another in a suitable manner such that, on the one hand, the demands placed on the strength of the joint will be fulfilled, and, on the other, a type of connection can be selected which can be easily manufactured and, at the same time, fulfils the requirements made on the visual appearance image of the connection area in the visible part. Thus, for example, bodywork panels consisting of a lightweight metal material, such as an aluminium or magnesium alloy, cannot as a rule be welded to the load-bearing structure of an individual vehicle if it is made of steel. This problem makes it difficult for the advantages of the different materials, namely the low weight for the outer skin or the lightweight metal used for the other structures of the vehicle on the one hand, and the high strength of steel for the manufacture of the parts of the bodywork subjected to high loading on the other, to be exploited in combination. These problems arise if it is intended that plastic parts should be connected to metal parts.

Attempts have indeed been made to achieve the connection of components manufactured from different materials to one another by adhesively bonded connections. Frequently, however, these connections are in practice not capable of meeting the loads imposed. This applies, for example, in cases when a sheet metal component manufactured from a lightweight material is to be connected to a profile manufactured from a strong material. The tensions which arise in the region of the adhesively bonded part can lead to a weakening of the joint, in particular after extended use.

As an alternative or supplement to adhesive bonding, components consisting of different materials that cannot be welded together can also be connected to one another with a positive or non-positive connection. Thus, for example, light metal or plastic parts can be riveted or screwed to a component made of steel. In the sector of bodywork or other housing construction, however, this type of connection frequently has the disadvantage that the connection elements are visible from the outside and interfere with the visual appearance image of the individual product. In addition to this, the manufacture of non-positive connections in fully-automated or partially-automated manufacturing operation can frequently only be achieved with increased expenditure on apparatus and is correspondingly expensive.

A further possibility of manufacturing components made of different materials which cannot be welded together is known from EP 0 868 237 B1. In this patent specification a method is presented which is made from at least two joined parts which are connected to one another exclusively by clamping force.

The manufacture of the known metal profiles in this situation is effected in that, first, a slot is formed in one of the parts which are to be joined. During this forming, a change of structure takes place in the immediate vicinity of the slot. Another part, made of flat material, is then inserted with its narrow side into this slot, and clamped fast in the slot by crushing the material close to the slot in the other part. In this situation a further structural change takes place, so that an exclusively positive and non-positive connection is produced between the two parts which are to be connected. In this manner parts made from any desired metals can be joined which are not suitable or not best suited for the other joining techniques, whether due to the combination of materials or for other reasons.

A disadvantage of the method known from EP 0 868 237 B1 is that a particular material thickness is an essential precondition, at least in the region of the element in which the slot is formed. In addition to this, according to the known method, adequate deformability is required of the component provided with the slot in the regions adjacent to the slot. Finally, the forming of the slot in the one element, the insertion of the other element into the slot, and the subsequent pressing of the material, can only be carried out in a complex manufacturing process. This is not suitable in particular for the connection of bodywork components of large surface area with low thickness to a carrying profile of which the walls are substantially thicker in comparison with the thickness of the outer part concerned.

Taking the prior art described heretofore as a starting point, the invention is based on the object of creating means which will allow in a simple manner for the reliable connection of two components made of different materials. In addition to this, a component is to be provided which can be manufactured in a particularly simple manner from components which consist of different materials.

With regard to the connection means, this object is resolved by an adapter which is intended to connect a component consisting of a first material to a component consisting of a second material, this adapter according to the invention being characterised in that it has a basic element which is manufactured from a material which belongs to the group of materials to which the material of the first component is allocated, and a connection element which is indissolubly connected to the basic element in a positive and non-positive manner by a joining operation, said connection element being made of a material which belongs to the group of materials to which the material of the second component is allocated.

With the adapter according to the invention, means are provided with which components consisting of the most widely differing materials can be reliably and simply connected to one another. Such an adapter can be prefabricated without any problem, and so enables simple and economical assembly, with low technical expenditure, of components which consist of different and mutually incompatible materials.

The invention takes advantage in this situation of the method basically known from EP 0 868 237 B1. Thus, with the adapter according to the invention, provision is made for a basic element into which the connection element is joined, for example by the use of the method known from EP 0 868 237 B1 or a comparable method. In this situation the basic element consists of a material which is compatible with the material from which one of the components are made which are to be joined to one another, while the connection element consists of a material which belongs to the group of materials from which the other of the components is manufactured. Due to the fact that it is manufactured from components which in each case consist of the same or closely related materials as the components assigned to them during the assembly, the adapter according to the invention can be connected with no problem to both components by metallurgical or material joining. The result achieved is that, on the one hand, the adapter is connected securely to the components which are to be connected to one another, and, on the other, the components are securely connected via the joining region of the adapter and reliably connected to one another.

Accordingly, a particularly practical embodiment of the invention makes provision for the basic element to have a slot, into which a section of the connection element is placed, and the edges of the slot are then pressed at least section by section by means of a structure-changing operation against the section of the connection element located in the slot in such a way that the positive and non-positive connection is formed between the basic element and the connection element.

With regard to a component which consists of a first component which consists of a first material, and a second component which consists of a material which belongs to a group of materials which is different from the material of the first element, the problem described heretofore is resolved in that the components are connected to one another by an adapter designed according to the invention.

With the aid of the adapter according to the invention, components for example can be connected to one another in a particularly simple manner with which one component is manufactured from a steel material and the other component from a lightweight metal material. In just as simple a manner, however, with an adapter according to the invention, a component made, for example, of a plastics material, can be connected to an element consisting of steel or a lightweight metal material. These properties make the adapter according to the invention particularly well-suited for the connection of parts of the outer skin or other structural components of a bodywork to a component assigned to the load-bearing structure of the individual motor vehicle. Thus, with the adapter according to the invention, structural components such as external or internal sheet components of a vehicle bodywork, which consist of a particularly lightweight aluminium or magnesium alloy, can be connected in a simple manner to profiles of the load-bearing structure of the vehicle consisting of a high-strength steel or other materials. Because the connection between the external sheet part and the adapter can be welded, no connection elements which interfere with the visual impression are required in the region of the connection between adapter and external sheet. In addition, it is also not necessary for special shaping elements for the connection to the adapter to be formed on the external sheet part or on the profile.

Other advantageous embodiments of the invention are described in the dependent claims and are explained hereinafter in greater detail in connection with the embodiments represented in the drawings.

The figures show in diagrammatic form in each case, in a perspective view, four connections V1, V2, V3 V4, between a thin external sheet A1, A2, A3, A4 shown in section only, and in each case a load-bearing profile T1, T2, T3, T4 of a motor vehicle bodywork, not further represented.

The external sheets A1, A2, A3, A4 form in each case the first component of a bodywork component, the second component of which is formed by the individual load-bearing profiles T1, T2, T3, T4. The external sheets A1, A2, A3, A4 consist in this situation, for example, of an aluminium or magnesium material, while the load-bearing profiles T1, T2, T3, T4 are manufactured, for example, in each case from a high-strength steel alloy which in practical use can reliably resist the loads arising in the individual vehicle.

The connection between the individual external sheets A1, A2, A3, A4 and the load-bearing profile T1, T2, T3, T4 assigned to them in each case is formed in each case by an adapter 1, 2, 3, 4. Each of the adapters 1, 2, 3, 4 has a plate-shaped basic element 5, 6, 7, 8, which is assigned to the individual external sheet A1, A2, A3, A4 and consists of the same lightweight metal material as the external sheet A1, A2, A3, A4 concerned.

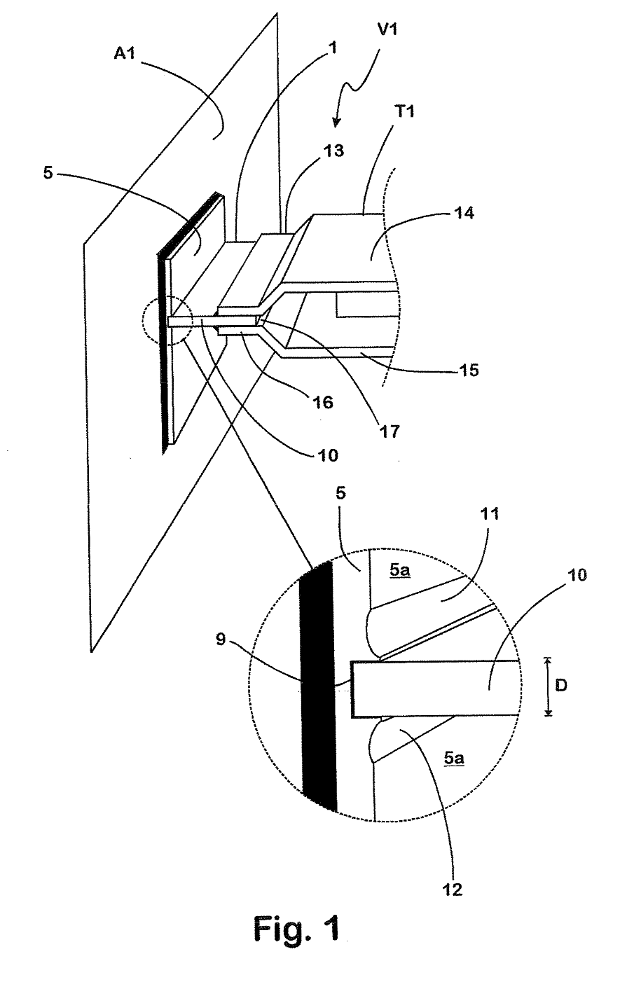

During the manufacture of the adapter 1 used for the connection V1 (FIG. 1) a slot 9 is formed into the basic element 5, extending transversely across the basic element 5. The width of the slots 9 corresponds in this situation with the thickness D of a likewise plate-shaped connection element 10, which is inserted with its narrow side into the slot 9. The connection element 10 consists of a steel material which can be satisfactorily welded to the steel of the load-bearing profile T1.

After the insertion into the slot 9, pressure rollers, not shown, are moved under high contact pressure at a short distance interval to the slot 9, along this slot 9 over the surface 5a of the basic element 5 allocated to the connection element 10. The contact pressure exerted by the pressure rollers in this situation is so great that regions 11, 12 of the material of the basic element 5, displaced by this pressure, taking the form of small slots after the deformation and extending parallel to the slot 9, flow in the direction of the slot 9, so that the side surfaces of the slot 9 take effect with high pressure force on the surface sections allocated to them in each case of the connection element 10. The positive and non-positive connection created in this way between the connection element 10 and the basic element 5 is so strong that the connection element 10 is held securely and permanently in the basic element 5 even under high alternating loading.

The load-bearing profile T1 has an I-shaped cross-section. Formed at its end facing the adapter 1 is a connection piece 13, in which the upper section 14 and lower section 15 of the load-bearing profile T1, starting from their normal position spaced apart from one another, initially run obliquely to one another, in order then to run parallel to one another again over a short section 16. The height of the gap 17 formed in this way in the region of the section 16, between the upper section 14 and the lower section 15 of the load-bearing profile T1, corresponds in this situation essentially to the thickness D of the connection element 10 of the adapter 1.

To connect the external sheet A1 to the load-bearing profile T1, first the basic element 5 of the adapter 1 is welded to the external sheet 1, so that external sheet 1 and adapter are securely connected to one another by material or metallurgical joining. Next, the connection element 10 of the adapter 1 is pushed with its narrow side, facing away from the basic element 5, into the gap 17 of the load-bearing profile T1. The load-bearing profile T1 and the connection element 10 can then be easily and reliably welded together in the region of the overlap formed in this way, so that the load-bearing profile T1 and the adapter 1 are securely connected to one another by metallurgical joining. The connection of the external sheet A1 and the load-bearing profile T1 is in this situation guaranteed by the positive and non-positive connection present in the region of the slot 9 between the connection element 10 and the basic element 5.

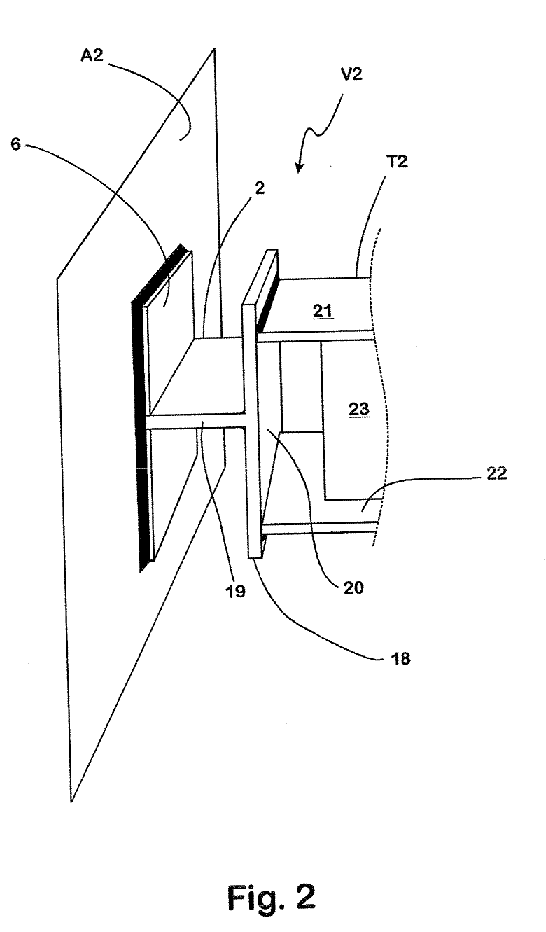

With the adapter 2 used for the connection V2 (FIG. 2), the connection element 18 is not plate-shaped, but formed in the manner of a T-profile. The free narrow side of the web 19 of the connection element 18 is in this case, in the same manner as described heretofore for the joining of the connection element 10 and the basic element 5 in the slot 9 of the adapter 1, securely connected positively and non-positively to the base plate 6 of the adapter 2.

The free connection surface 20 of the connection element 18 facing away from the web 19 can in this way be used for the connection of the individual load-bearing profile T2. The connection element 18 in this case also consists of a steel material, which can be particularly satisfactorily welded to the steel of the load-bearing profile T2.

With the connection V2, this load-bearing profile T2 likewise has an I-shaped cross-section. To enable a simple connection to the adapter, the upper section 21 and the lower section 22 are lengthened at the end of the load-bearing profile T2 facing the adapter 2 out over the web 23 of the profile, in such a way that they abut in flat contact at the connection surface 20 of the connection element 18 and can there be easily welded to the connection element 18. The basic element 6 of the adapter 2 is at the same time welded to the external sheet A2, so that, with the connection V2 also, the external sheet A2 ¹[and the load-bearing profile T2] are securely connected to one another by means of the positive and non-positive connection between the basic element 6 and the connection element 18 of the adapter 2.

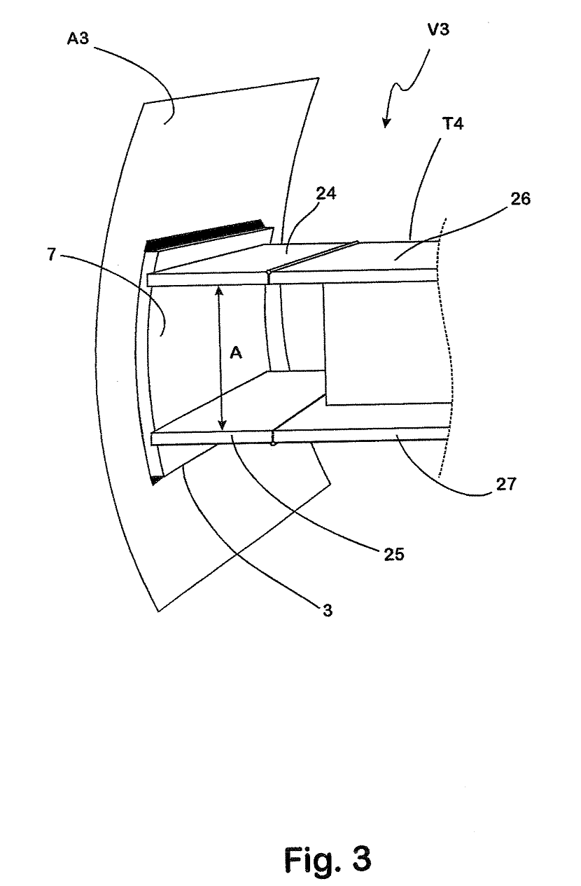

With the connection V3 (FIG. 3), the end of the load-bearing profile T3 to be connected to the external sheet A3 is designed in exactly the same way as the end of the load-bearing profile T2 assigned to the external sheet A2. Because the external sheet A3 is designed to be cambered in the region of the connection V3, the plate-shaped basic element 7 of the adapter 3 used for the connection V3 is designed in a corresponding manner to be cambered in such a way that, at the adapter 3 located at the external sheet A3, the basic element 7 is in snug contact with the external sheet A4.

For the connection to the load-bearing profile T3, the adapter 3 has two plate-shaped connection elements 24, 25, consisting of the same easily-weldable steel material as the load-bearing profile T3, which connection elements are arranged parallel to one another at a distance interval A which corresponds to the distance interval between the upper section 26 and the lower section 27 of the load-bearing profile T3. The connection elements 24, are also joined in each case in the same manner to the basic element 7 of the adapter 3 as has been described heretofore for the connection between the basic element 5 and the connection element 10 of the adapter 1.

To connect the external sheet A3 to the load-bearing profile T3, the adapter 3 with its basic element 7 is first placed in contact with the external sheet A3 and welded to it. Next, the adapter 3 with the external sheet A3 is placed in contact at the end of the load-bearing profile T3 in such a way that the free ends of its connection elements 24, 25, facing away from the basic element 7, abut flat against the free ends of the upper section 26 and the lower section 27 of the load-bearing profile T3. In the region of the joint formed in this way it is then possible for the adapter 3 and the load-bearing profile T3 to be welded to one another with no problem.

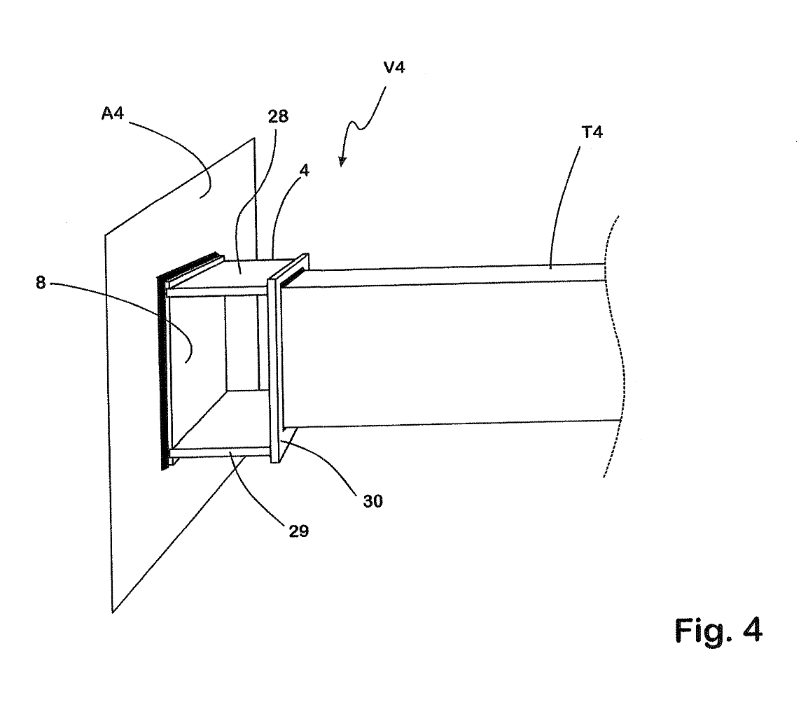

The adapter 4 used for the connection V4 (FIG. 4) has, in addition to the plate-shaped basic element 8, made of the same material as the external sheet A4 and welded to it, connection elements 28, 29, designed to correspond to the connection elements 24, 25 present at the adapter 3, and connected positively and non-positively to the basic element 8. By contrast with the adapter 3, however, these connection elements 28, 29, at the adapter 4 carry a connection plate 30 with their end that faces away from the basic element 8, which connection plate consists of a steel material, which can be satisfactorily welded to the steel material of the load-bearing profile T4. The plate-shaped connection elements 28, 29, can in this situation consist of the same material as the connection plate 30 and are welded to it.

As an alternative, however, it is also possible for the connection elements 28, 29 to be manufactured from another material, and for them likewise, for example, to be connected to the connection plate 30 in accordance with the pattern of the connection between them and the basic element 8. In this case, the connection elements 28, 29, can, for example, consist of a resilient material, which prevents the transfer of vibrations from the load-bearing profile T4 onto the external sheet A4 to which it is to be connected.

The connection plate 30 in this situation enables the problem-free connection of tubular load-bearing profiles T4 to the adapter 4. To do this, the load-bearing profile T4 is placed with its free end abutting flat against the connection plate 30 of the adapter, so that simple welding can be carried out in the region of the joint formed in this way.

1. Adapter for the connection of a component (A1, A2, A3, A4) consisting of a first material to a component (T1, T2, T3, T4) consisting of a second material, wherein it has a basic element (5, 6, 7, 8), which is manufactured from a material which belongs to the group of materials to which the material of the first component (A1, A2, A3, A4) is allocated, and a connection element (10, 19, 24, 25, 28, 29), indissolubly connected by a joint operation in a positive and non-positive manner to the basic element (5, 6, 7, 8), said connection element being manufactured from a material which belongs to the group of materials to which the material of the second component (T1, T2, T3, T4) is allocated, and in that the positive and non-positive indissoluble connection of basic element (5, 6, 7, 8) and connection element (10, 19, 24, 25, 28, 29) is formed in such a way that the basic element (5, 6, 7, 8) has a slot (9), into which a section of the connection element (10, 19, 24, 25, 28, 29) is located, and in that the edges of the slot (9) are pressed, at least section by section, by a structure-alternating operation in such a way against the section of the connection element (10, 19, 24, 25, 28, 29) located in the slot that the positive and non-positive connection is established between the basic element (5, 6, 7, 8) and the connection element (10, 19, 24, 25, 28, 29).

2. Adapter according to claim 1, wherein the basic element (5, 6, 7, 8) has a slot (9), into which a section of the connection element (10, 19, 24, 25, 28, 29) is located, and in that the edges of the slot (9) are pressed at least section by section by a structure-altering operation against the section of the connection element (10, 19, 24, 25, 28, 29) located in the slot (9) in such a way that the positive and non-positive connection is formed between the basic element (5, 6, 7, 8) and the connection element (10, 19, 24, 25, 28, 29).

3. Adapter according to claim 1, wherein the basic element (5, 6, 7, 8) is a plate.

4. Adapter according to claim 1, wherein the connection element (10, 24, 25, 28, 29) is a plate.

5. Adapter according to claim 1, wherein the connection element (1) is a T-profile piece.

6. Adapter according to claim 1, wherein the material of at least one of the components (A1, A2, A3, A4, T1, T2, T3, T4) is a metal alloy.

7. Adapter according to claim 6, wherein the material of one of the components (A1, A2, A3, A4, T1, T2, T3, T4) is a plastic.

8. Adapter according to claim 6, wherein the materials of both components (A1, A2, A3, A4, T1, T2, T3, T4) are allocated to different groups of metals.

9. Adapter according to claim 8, wherein the first material is a steel material and the second material is a lightweight metal material.

10. Adapter according to claim 9, wherein the second material is an aluminium material.

11. Component manufactured from a first component (A1, A2, A3, A4), which consists of a first material, and from a second component (T1, T2, T3, T4), which is manufactured from a material belonging to a material group which is other than the material of the first component (A1, A2, A3, A4), wherein the components (A1, A2, A3, A4, T1, T2, T3, T4) are connected to one another by an adapter (1, 2, 3, 4) designed in accordance with claim 1.

12. Component according to claim 11, wherein the one component (T1, T2, T3, T4) is manufactured from a steel material and the other component (A1, A2, A3, A4) is manufactured from a lightweight metal material.

13. Component according to claim 11, wherein the one component (A1, A2, A3, A4) is a sheet, and the other component (T1, T2, T3, T4) is a profile.
